(19) United States
(12) Patent Application Publication
(10) Pub. No.: US 2009/0244426 A1
(43) Pub. Date: Oct. 1, 2009

(54) LIQUID CRYSTAL DISPLAY AND DRIVING METHOD THEREOF

(76) Inventors: Rei HASEGAWA, Yokohama-shi (JP); Yuko Kizu, Yokohama-shi (JP); Yukio Kizaki, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/366,884

(22) Filed: Feb. 6, 2009

(30) Foreign Application Priority Data
Mar. 27, 2008 (JP) 2008-083591

(51) Int. Cl. G02F 1/1368; G02F 1/1337; G09G 3/36

(52) U.S. Cl. 349/48; 349/123; 345/94

(57) ABSTRACT

An array substrate of a liquid crystal display includes an insulating substrate, signal line groups supported by the insulating substrate and each including first and second signal lines, and pixel circuits arranged along the signal line groups. Each of the pixel circuits includes first and second pixel electrodes, a first switch connected between the first pixel electrode and the first signal line, and a second switch connected between the second pixel electrode and the second signal line.

### CROSS-REFERENCE TO RELATED APPLICATIONS

This application is based upon and claims the benefit of priority from prior Japanese Patent Application No. 2008-083591, filed Mar. 27, 2008, the entire contents of which are incorporated herein by reference.

### BACKGROUND OF THE INVENTION

1. Field of the Invention

The present invention relates to a liquid crystal display technique.

2. Description of the Related Art

In a liquid crystal display employing the optically compensated bend (OCB) mode or the π cell mode, liquid crystal material is allowed to form bend configuration. In such a display, the tilt angle of liquid crystal molecules near the alignment layers is changed so as to cause a retardation change in a liquid crystal layer.

In the initial state before power-up, the liquid crystal material forms the splay configuration in the display employing the OCB mode or the π cell mode. This is because the splay configuration is more stable than the bend configuration. Thus, on startup of the display employing the OCB mode or the π cell mode, a procedure is performed to cause the orientational structure of the liquid crystal material change from the splay configuration to the bend configuration. Further, as described in JP-A 2003-140113 (KOKAI) and JP-A 2007-183563 (KOKAI), in some cases, application of a reset voltage to the liquid crystal layer by means of electrodes sandwiching the liquid crystal layer is repeated at a constant time interval after the startup is completed in order to prevent the transition from the bend configuration to the splay configuration from occurring.

The liquid crystal display employing the OCB mode or the π cell mode can achieve a higher speed of response as compared with liquid crystal displays employing other display mode such as the in-plane switching (IPS) mode and the vertically aligned (VA) mode. However, even the liquid crystal display employing the OCB mode or the π cell mode has not achieved the speed of response comparable to that of cathode-ray tube (CRT) display.

### BRIEF SUMMARY OF THE INVENTION

According to a first aspect of the present invention, there is provided a liquid crystal display comprising an array substrate comprising a first insulating substrate, signal line groups supported by the first insulating substrate and each including first and second signal lines, and pixel circuits arranged along the signal line groups and each including first and second pixel electrodes, a first switch connected between the first pixel electrode and the first signal line included in one of the signal line groups, and a second switch connected between the second pixel electrode and the second signal line included in the one of the signal line groups, a counter substrate comprising a second insulating substrate facing the first insulating substrate with the pixel circuits interposed therebetween, and a counter electrode supported by the second insulating substrate and facing the pixel circuits, and a liquid crystal layer interposed between the array substrate and the counter substrate.

According to a second aspect of the present invention, there is provided a method of driving a liquid crystal display comprising an array substrate comprising a first insulating substrate and pixel circuits each including first and second pixel electrodes facing the first insulating substrate, a counter substrate comprising a second insulating substrate facing the first insulating substrate with the pixel circuits interposed therebetween and a counter electrode supported by the second insulating substrate and facing the pixel circuits, and a liquid crystal layer interposed between the array substrate and the counter substrate, comprising selecting the pixel circuits one-by-one or line-by-line, executing a pre-write operation including supplying first and second pre-write signals to the first and second pixel electrodes included in the selected pixel circuit, respectively, to apply a pre-write voltage between the first and second pixel electrodes, and after the pre-write operation, executing a write operation including supplying first and second video signals to the first and second pixel electrodes included in the selected pixel circuit, respectively, an absolute value of a difference between the first and second video signals being smaller than an absolute value of the pre-write voltage.

### BRIEF DESCRIPTION OF THE SEVERAL VIEWS OF THE DRAWING

FIG. 1 is a plan view schematically showing a liquid crystal display according to a first embodiment of the present invention;

FIG. 2 is a plan view schematically showing a display panel of the liquid crystal display shown in FIG. 1;

FIG. 3 is a cross-sectional view taken along the line III-III of the display panel shown in FIG. 2;

FIG. 4 is a timing chart showing an example of a method of driving the liquid crystal display shown in FIG. 1;

FIG. 5 is a timing chart showing another example of a method of driving the liquid crystal display shown in FIG. 1;

FIG. 6 is a timing chart showing still another example of a method of driving the liquid crystal display shown in FIG. 1; and

FIG. 7 is a plan view schematically showing a display panel of a liquid crystal display according to the second embodiment of the present invention.

### DETAILED DESCRIPTION OF THE INVENTION

Embodiments of the present invention will be described below with reference to the accompanying drawings. Note that the same reference numerals in the drawings denote components that achieve the same or similar functions, and a repetitive explanation thereof will be omitted.

The first embodiment of the present invention will be described first.

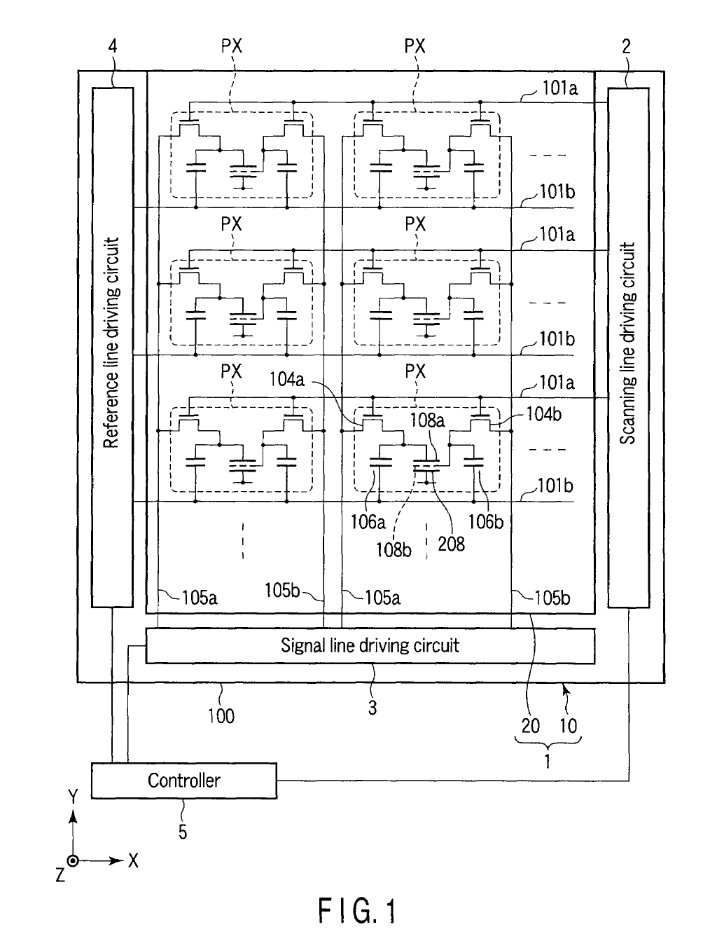

The liquid crystal display shown in FIG. 1 is an OCB-mode active matrix liquid crystal display. The liquid crystal display includes a liquid crystal display panel 1; a backlight (not shown) that faces the liquid crystal display panel 1; a scanning line-driving circuit 2, a signal line-driving circuit 3 and a reference line-driving circuit 4 each connected to the liquid crystal display panel 1; and a controller 5 connected to the driving circuits 2 to 4.

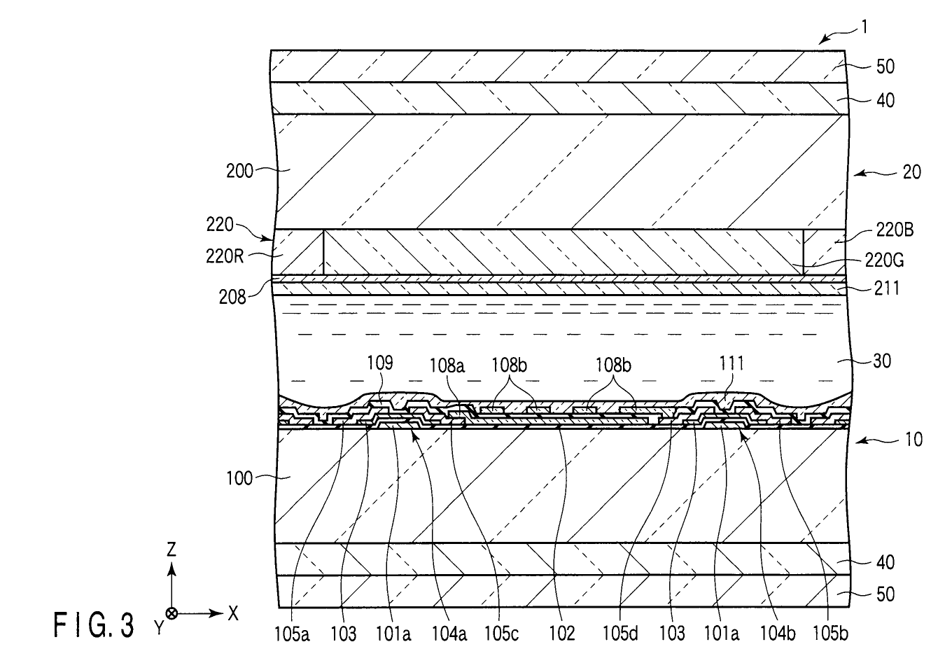

As shown in FIGS. 1 and 3, the liquid crystal display panel 1 includes an array substrate 10 and a counter substrate 20. A frame-shaped sealing layer (not shown) is interposed between the array substrate 10 and the counter substrate 20. A space surrounded by the array substrate 10, the counter substrate 20, and the sealing layer is filled with a liquid crystal material. This liquid crystal material forms a liquid crystal layer 30. An optical compensation film 40 and a polarizer 50 are placed on the outer surface of the array substrate 10 in this order. On the outer surface of the counter substrate 20, an optical compensation film 40 and a polarizer 50 are also placed in this order.

The array substrate 10 includes a light-transmitting substrate 100 as shown in FIGS. 1 and 3. The substrate 100 is, for example, a glass or plastic substrate.

On the substrate 100, scanning lines 101a and reference lines 101b are arranged as shown in FIGS. 1 to 3. The scanning lines 101a and the reference lines 101b run in the X-direction, and are alternately arranged in the Y-direction crossing the X-direction.

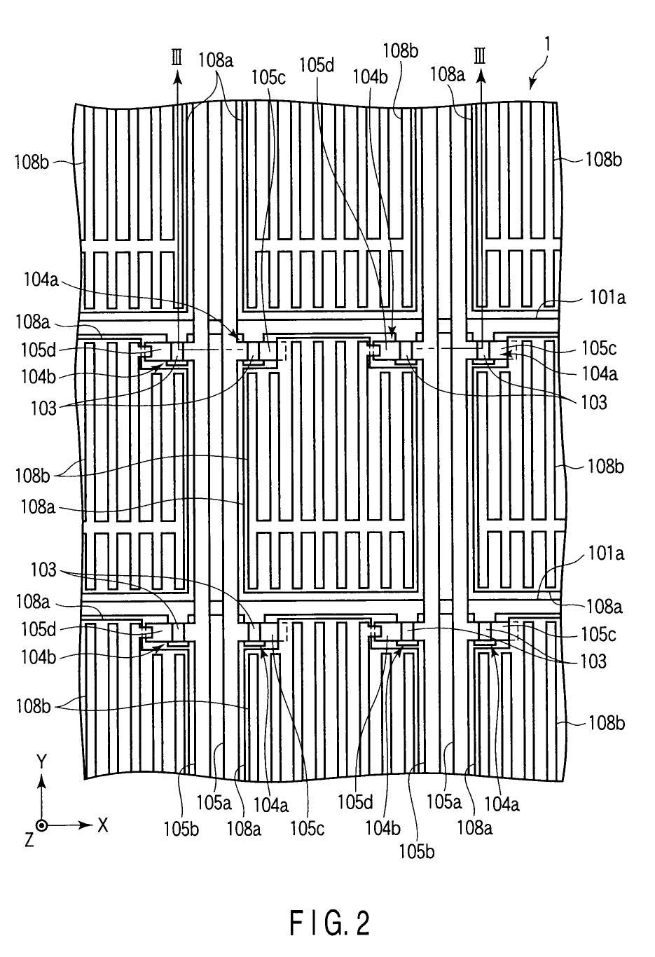

Note that the color filter layer to be described later and the reference lines (auxiliary capacitive lines) 102b are omitted in FIG. 2. Note also that the X-direction and the Y-directions are parallel with a main surface of the substrate and are directions crossing each other. The Z-direction to be described later is the direction perpendicular to the X-direction and the Y-direction.

Each of the scanning lines 101a includes projections that project in the Y-direction. The projections are utilized as the gate electrodes of thin-film transistors to be described later.

Each of the reference lines 101b includes projections that project in the Y-direction. The projections are utilized as the electrode of capacitors to be described later.

The scanning lines 101a and the reference lines 101b can be formed simultaneously. As the material of these lines, it is possible to use, e.g., a metal or alloy.

The scanning lines 101a and the reference lines 101b are covered with an insulating film 102 as shown in FIG. 3. As the insulating film 102, a silicon oxide film can be used, for example.

On the insulating film 102, semiconductor layers 103 are arranged correspondently with the gate electrodes described above. The semiconductor layers 103 intersect the gate electrodes. The semiconductor layers 103 are made of, e.g., amorphous silicon.

The gate electrodes, the semiconductor layers 103, and those portions of the insulating film 102 that are positioned between the gate electrodes and the semiconductor layers 103, i.e., gate insulators, form thin-film transistors. These thin-film transistors are utilized as switches 104a and 104b as shown in FIGS. 1 and 2.

Note that in this embodiment, the switches 104a and 104b are n-channel thin-film transistors. Note also that a channel protection layer and ohmic layer (neither is shown) are formed on each semiconductor layer 103.

The switches 104a and 104b may be p-channel thin-film transistors. Alternatively, the switches 104a and 104b may be other switching elements such as diodes.

On the insulating film 102, signal lines 105a and 105b and source electrodes 105c and 105d are further arranged as shown in FIG. 3.

The signal lines 105a run in the Y-direction, and are arranged in the X-direction correspondently with the columns that the pixel switches 104a form as shown in FIG. 2. The signal lines 105a cover the drains of the semiconductor layers 103 included in the pixel switches 104a. That is, portions of each signal line 105a are drain electrodes connected to the pixel switches 104a.

The signal lines 105b run in the Y-direction, and are arranged in the X-direction correspondently with the columns that the pixel switches 104b form as shown in FIG. 2. The signal lines 105b cover the drains of the semiconductor layers 103 included in the pixel switches 104b. That is, portions of each signal line 105b are drain electrodes connected to the pixel switches 104b.

The source electrodes 105c are arranged correspondently with the pixel switches 104a as shown in FIG. 2. The source electrodes 105c cover the sources of the switches 104a, and face the reference lines 101b. The source electrodes 105c, the reference lines 101b, and the insulating film 102 interposed between them form capacitors 106a.

The source electrodes 105d are arranged correspondently with the pixel switches 104b as shown in FIG. 2. The source electrodes 105d cover the sources of the switches 104b, and face the reference lines 101b. The source electrodes 105d, the reference lines 101b, and the insulating film 102 interposed between them form capacitors 106b.

First pixel electrodes 108a shown in FIGS. 1 to 3 are further arranged on the insulating film 102. As shown in FIGS. 2 and 3, the pixel electrodes 108a at least partially cover the source electrodes 105c, respectively. Indium tin oxide (ITO) or the like can be used as the material of the pixel electrodes 108a.

Each pixel electrode 108a is a continuous film with no opening. Each pixel electrode 108 may be provided with an opening at a position facing the pixel electrode 108b to be described later.

The pixel electrodes 108a are covered with an insulating film 109 as shown in FIG. 3. The insulating film 109 is, for example, a transparent inorganic layer such as silicon oxide layer or silicon nitride layer. As the insulating film 109, a transparent organic layer may be used.

Typically, the pixel electrodes 108a and 108b are transparent electrodes. In the case where the liquid crystal display is of reflective type, the pixel electrodes 108a and 108b may be reflective electrodes. In the case where the liquid crystal display is of transreflective type, each of the pixel electrodes 108a and 108b may includes a reflecting portion and a transmitting portion.

On the insulating film 109, the second pixel electrodes 108b are arranged correspondingly with the first pixel electrode 108a as shown in FIGS. 2 and 3. The pixel electrodes 108b are electrically insulated from the pixel electrodes 108a and at least partially cover the source electrodes 105d, respectively. As the material of the pixel electrodes 108b, ITO can be used, for example.

Each pixel electrode 108b faces only a part of the pixel electrodes 108a. Each pixel electrode 108b is provided with slits each extending in the Y-direction and arranged in the X-direction.

The insulating film 109 and the pixel electrodes 108a and 108b are covered with an alignment layer 111 as shown in FIG. 3. The alignment layer 111 orients nearby liquid crystal molecules at a relatively large pretilt angle of, e.g., 5° to 10°. The alignment layer 111 can be obtained by performing an alignment treatment process such as rubbing on an organic film made of, e.g., acryl, polyimide, nylon, polyamide, polycarbonate, benzocyclobutene polymer, polyacrylonitrile, or polysilane. Alternatively, deposition of silicon oxide or the like by oblique evaporation may be performed in order to obtain the alignment layer 111. Of these materials, polyimide, polyacrylnitrile, and nylon are superior in the ease of film formation and the chemical stability.

The alignment layer 111 may tilt the liquid crystal molecules in any direction. Typically, the direction in which the alignment layer 111 tilts the liquid crystal molecules is set such that the orthogonal projection of this direction onto the XY plane orthogonally or obliquely intersects the longitudinal direction of comb teeth of the pixel electrodes 108b. Here, as an example, it is assumed that a polyimide film rubbed along the X-direction is used as the alignment layer 111.

Note that the switches 104a and 104b, the capacitors 106a and 106b, and the pixel electrodes 108a and 108b form pixel circuits. In each pixel circuit, one or two of the capacitors 106a and 106b may be omitted.

The counter substrate 20 includes a light-transmitting substrate 200 as shown in FIG. 3. The substrate 200 is, for example, a glass substrate or a plastic substrate.

On the substrate 200, a black matrix (not shown) and a color filter layer 220 shown in FIG. 3 are formed in this order.

The black matrix is a light-shielding layer provided with openings at positions facing the pixel electrodes 108. For example, the black matrix is a patterned layer having a grid shape or a stripe shape. As the material of the black matrix, metal such as chromium or alloy can be used, for example.

The color filter layer 220 includes a red coloring layer 220R, a green coloring layer 220G and a blue coloring layer 220B. The coloring layers 220R, 220G and 220B form a stripe arrangement correspondently with the columns of the pixel circuits. The coloring layers 220R, 220G and 220B may form other arrangement such as delta arrangement or rectangular arrangement.

On the color filter layer 220, a counter electrode 208 shown in FIGS. 1 and 3 is formed. The counter electrode 208 is a common electrode facing the pixel electrodes 108a and 108b. ITO or the like can be used as the material of the counter electrode 208.

The counter electrode 208 is covered with an alignment layer 211 shown in FIG. 3. A film similar to the alignment layer 111 can be used as the alignment layer 211. In this embodiment, a polyimide film that is rubbed in the same direction as the alignment layer 111 is used as the alignment layer 211.

As shown in FIG. 3, the array substrate 10 and counter substrate 20 oppose the alignment layers 109 and 209 to each other. A frame-shaped sealing layer (not shown) is interposed between the array substrate 10 and counter substrate 20. The sealing layer adheres the array substrate 10 to the counter substrate 20. An adhesive can be used as the material of the sealing layer.

A transfer electrode (not shown) is formed between the array substrate 10 and counter substrate 20 at a position outside the frame formed by the sealing layer. This transfer electrode electrically connects the counter electrode 208 to the array substrate 10.

Granular spacers are interposed between the array substrate 10 and counter substrate 20, or the array substrate 10 and/or the counter substrate 20 further include columnar spacers. These spacers form a gap having a substantially constant thickness at positions corresponding to the pixel electrodes 108a between the array substrate 10 and counter substrate 20.

A space surrounded by the array substrate 10, counter substrate 20, and sealing layer is filled with a liquid crystal material. The liquid crystal material forms the liquid crystal layer 30 shown in FIG. 3. As the liquid crystal material, a nematic liquid crystal material having positive dielectric anisotropy can be used, for example.

The pixel electrodes 108a and 108b, the counter electrode 208, the alignment layers 111 and 211, and the liquid crystal layer 30 form liquid crystal elements. Each pixel PX shown in FIG. 1 includes the liquid crystal element, the switches 104a and 104b, and the capacitors 106a and 106b. Each pair of the signal lines 105a and 105b connected to the same pixel PX constitute a signal line group. Also, the array substrate 10, the counter substrate 20, and the liquid crystal layer 30 and sealing layer interposed between these substrates form a liquid crystal cell.

The optical compensation films 40 shown in FIG. 3 are, e.g., biaxial films. As the optical compensation films 40, it is possible to use a film including an optical anisotropic layer in which a uniaxial compound having negative refractive anisotropy, e.g., a discotic liquid crystal compound forms bend configuration such that the optic axis of the compound changes in a plane perpendicular to the X-direction.

The retardation of each optical compensation film 40 is made substantially half the retardation of the liquid crystal layer 30 in the on state, for example. In this case, the optical compensation films 40 are placed such that the retardation of a stacked structure of the optical compensation films 40 and liquid crystal layer 30 in the on state is substantially zero.

The polarizers 50 shown in FIG. 3 are so arranged that, e.g., their transmission axes are substantially perpendicular to each other. Also, the polarizers 50 are so arranged that, e.g., their transmission axes make an angle of about 45° with each of the X-direction and Y-direction.

To the scanning line-driving circuit 2, the scanning lines 101a are connected as shown in FIG. 1. The scanning line-driving circuit 2 sequentially supplies first scanning voltage that makes the switches 104a and 104b closed to the scanning lines 101a. The scanning line-driving circuit further supplies second scanning voltage that makes the switches 104a and 104b open to the scanning lines 101a to which the first scanning voltage is not supplied.

To the signal line-driving circuit 3, the signal lines 105a and 105b are connected as shown in FIG. 1. The signal line-driving circuit 3 supplies first and second signal voltages to the signal lines 105a and 105b, respectively. To be more specific, the signal line-driving circuit 3 supplies a first reset signal, a first pre-write signal and a first video signal as a first signal voltage to each of the signal lines 105a. The signal line-driving circuit 3 further supplies a second reset signal, a second pre-write signal and a second video signal as a second signal voltage to each of the signal lines 105b.

To the reference line-driving circuit 4, the reference lines 101b are connected as shown in FIG. 1. When the signal line-driving circuit 3 reverses the polarity of the first and second video signals to be output to the signal lines 105a and 105b from positive to negative, for example, at the moment when it starts the supply of the reset signals to the pixels on which the video signals are to be written, the reference line-driving circuit 4 changes the potential of the reference line 101b connected to the pixels on which the video signals are to be written from a first potential to a second potential. Further, when the signal line-driving circuit 3 reverses the polarity of the first and second video signals to be output to the signal lines 105a and 105b from negative to positive, for example, at the moment when it starts the supply of the reset signals to the pixels on which the video signals are to be written, the reference line-driving circuit 4 changes the potential of the reference line 101b connected to the pixels on which the video signals are to be written from the second potential to the first potential. Note that the “polarity” refers to the polarity of the difference between the potential of the video signal and the potential of the counter electrode 208.

On of the driving circuits 2 to 4 includes a voltage source connected to the counter electrode 208. The voltage source includes a voltage source that controls the potential of the counter electrode 208. For example, the voltage source keeps the potential of the counter electrode 208 constant. Alternatively, the voltage source periodically changes the potential of the counter electrode 208 between a first constant potential and a second constant potential. In the latter case, the polarity of the first and second signal voltages, which the signal line-driving circuit 3 outputs, is reversed at the moment when the potential of the counter electrode 208 is changed to the first constant potential to the second constant potential and at the moment when the potential of the counter electrode 208 is changed to the second constant potential to the first constant potential.

The driving circuits 2 to 4 may be mounted by chip-on-glass (COG). Alternatively, the driving circuits 2 to 4 may be mounted by tape carrier package (TCP).

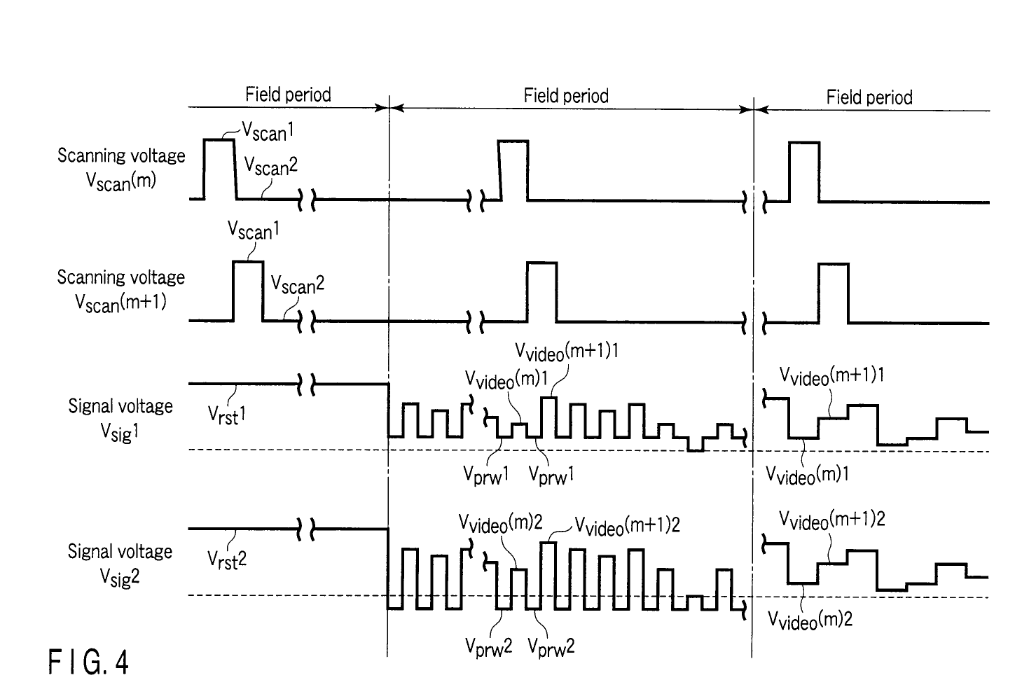

The controller 5 is connected to the driving circuits 2 to 4 as shown in FIG. 1. The controller 5 controls the operations of the driving circuits 2 to 4, for example, in accordance with the method to be described below with reference to FIG. 4.

In FIG. 4, the abscissa indicates time, and the ordinate indicates voltage. “V_{scan}1” and “V_{scan}2” represent the first and second scanning voltages, respectively. “Scanning voltage V_{scan}(m)” represents the waveform of the scanning voltage that the scanning line-driving circuit 2 outputs to the m-th scanning line 101a. “Signal voltage V_{sig}1” represents the waveform of the signal voltage that the signal line-driving circuit 3 outputs to the signal lines 105a connected to one of the pixels PX. “Signal voltage V_{sig}2” represents the waveform of the signal voltage that the signal line-driving circuit 3 outputs to the signal lines 105b connected to the particular pixel PX.

In the driving method shown in FIG. 4, three or more fields constitute each frame. In each frame period, a progressive scanning is executed. The signal line-driving circuit 3 simultaneously supplies signal voltages to all the signal line groups. Also, in this driving method, the potential V_{com} of the counter electrode 208 is kept constant.

In the first field period of each frame period, a reset operation is executed. To be more specific, in the first field period of each frame period, the signal line-driving circuit 3 supplies a first reset signal Vᵣₛₜ1 and a second reset signal Vᵣₛₜ2 to the signal lines 105a and 105b, respectively, under the control of the controller 5. Thus, in each pixel PX, the first voltage V1 between the pixel electrode 108 and the counter electrode 208 is set at a first reset voltage Vᵣₛₜ1−V_{com}, and the second voltage V2 between the pixel electrode 108b ad the counter electrode is set at a second reset voltage Vᵣₛₜ2−V_{com}.

The reset signals Vᵣₛₜ1 and Vᵣₛₜ2 are equal in potential, for example. An absolute value of the reset voltage Vᵣₛₜ1−V_{com} is, for example, equal to or larger than the maximum absolute value of the voltage applied between the pixel electrode 108a and the counter electrode 208 after the initial transition process for promoting configurational transition of a liquid crystal material from splay configuration to bend configuration. An absolute value of the reset voltage Vᵣₛₜ2−V_{com} is, for example, equal to or larger than the maximum absolute value of the voltage applied between the pixel electrode 108b and the counter electrode 208 after the initial transition process for promoting configurational transition of a liquid crystal material from splay configuration to bend configuration. The absolute value of the reset voltage Vᵣₛₜ1−V_{com} is set, for example, within a range of 3V to 8V. The absolute value of the reset voltage Vᵣₛₜ2−V_{com} is set, for example, within a range of 3V to 7V.

The reset voltage Vᵣₛₜ1−V_{com} may be larger in absolute value than the reset voltage Vᵣₛₜ2−V_{com} in consideration of the voltage drop due to the insulating film 109. That is, the reset voltages Vᵣₛₜ1−V_{com} and Vᵣₛₜ2−V_{com} may be set such that the voltage applied to the region of the liquid crystal layer 30 corresponding to the portion of the pixel electrode 108 not facing the pixel electrode 108b and the voltage applied to the region of the liquid crystal layer 30 corresponding to the pixel electrode 108b have the same magnitude. This makes it possible to prevent the decrease in contrast ratio due to the difference in transmittance between the portions corresponding to the above-described regions.

In the second field period of each frame period, a pre-write operation and a write operation are executed in this order in each selection period during which the scanning line-driving circuit 2 supplies the first scanning voltage to one of the scanning line 101a.

To be more specific, in each selection period, the scanning line-driving circuit 3 supplies a first pre-write signal V_{prw}1 and a second pre-write signal V_{prw}2 to the signal lines 105a and 105b, respectively, under the control of the controller 5. Thus, in each of the pixels PX, the third voltage V3 between the pixel electrodes 108a and 108b is set at a pre-write voltage V_{prw}1−V_{prw}2.

The pre-write voltage V_{prw}1−V_{prw}2 is larger in absolute value than the difference Vᵣₛₜ1−Vᵣₛₜ2 between the reset voltage Vᵣₛₜ1−V_{com} and the reset voltage Vᵣₛₜ2−V_{com}. The absolute value of the pre-write voltage V_{prw}1−V_{prw}2 is set, for example, within a range of 2V to 9V. Alternatively, the absolute value of the pre-write voltage V_{prw}1−V_{prw}2 is set, for example, within a range of 60% to 180% of the absolute value of the reset voltage Vᵣₛₜ2−V_{com}.

Typically, in the pixels in which the voltage V3 is set at the pre-write voltage V_{prw}1−V_{prw}2, the voltage V1 is smaller in absolute value than the reset voltage Vᵣₛₜ1−V_{com}, and the voltage V2 is smaller in absolute value than the reset voltage Vᵣₛₜ2−V_{com}. The absolute value of the voltage V1 is set, for example, a 90% or less of the absolute value of the reset voltage Vᵣₛₜ1−V_{com}. The absolute value of the voltage V2 is set, for example, a 90% or less of the absolute value of the reset voltage Vᵣₛₜ2−V_{com}.

Next, the signal line-driving circuit 3 supplies a first video signal voltage V_{video}1 and a second video signal voltage V_{video}2 to the signal lines 105a and 105b, respectively, under the control of the controller 5. Thus, the voltage V1 is set at a first video signal voltage V_{video}1−V_{com}, and the voltage V2 is set at a second video signal voltage V_{video}2−V_{com}. Note that in FIG. 4, “V_{video}(m)1” and “V_{video}(m)2” represent the video signals V_{video}1 and V_{video}2 to be written on one of the pixels PX in the m-th line, respectively.

Each of the video signals V_{video}1 and V_{video}2 is the signal that corresponds to the image to be displayed. For example, each of the video signals V_{video}1 and V_{video}2 corresponds to a grayscale level of the image to be displayed. The absolute value of the video signal voltage V_{video}1−V_{com} is equal to or smaller than the absolute value of the reset voltage Vᵣₛₜ1−V_{com}. The absolute value of the video signal voltage V_{video}2−V_{com} is equal to or smaller than the absolute value of the reset voltage Vᵣₛₜ2−V_{com}.

The absolute value of the video signal voltage V_{video}1−V_{com} may be greater than the absolute value of the video signal voltage V_{video}2−V_{com} in consideration of the voltage drop due to the insulating film 109. In other words, the video signals V_{video}1 and V_{video}2 may be set such that the voltage applied to the region of the liquid crystal layer 30 corresponding to the portion of the pixel electrode 108 not facing the pixel electrode 108b and the voltage applied to the region of the liquid crystal layer 30 corresponding to the pixel electrode 108b have the same magnitude. This makes it possible to prevent the decrease in contrast ratio due to the difference in transmittance between the portions corresponding to the above-described regions.

Then, by the same method as that described for the pixels PX in the m-th line, the pre-write operation and the write operation are executed in this order on each pixel PX in the m+1-th line. In the second field period of each frame period, the pre-write operations and the write operations are thus executed on all the pixels PX.

In the third and subsequent field periods of each frame period, the above-described write operations are executed. That is, the third and subsequent field periods of each frame period are the same as the second field period except that the pre-write operations are omitted.

In the driving method, the reset operations are executed at regular intervals as described above. Therefore, undesirable transition from the bend configuration to the spray configuration does not occur.

Generally, a liquid crystal display in which liquid crystal molecules form a bend configuration is relatively fast in response when the voltage applied to the liquid crystal layer is increased and is relatively slow in response when the voltage applied to the liquid crystal layer is decreased. For example, the response time when the voltage applied to the liquid crystal layer is changed from the maximum value to zero is several times to several ten times the response time when the voltage applied to the liquid crystal is changed to zero to the maximum value. This is because the electric field causes the change in configurational state when the voltage applied to the liquid crystal layer is changed from zero to the maximum value, while only the elastic force causes the change in configurational state when the voltage applied to the liquid crystal layer is changed from the maximum value to zero. For this reason, a sufficient response speed may not be achieved when the video signals that make the voltage applied to the liquid crystal zero are written on the pixels just after the reset operation.

The above pre-write operation includes setting the voltage V3 at the pre-write voltage V_{prw}1−V_{prw}2. That is, the pre-write operation includes applying a voltage between the pixel electrodes 108a and 108b to generate a transverse electric field almost perpendicular to the Z-direction in the vicinity of the alignment layer 111. The transverse electric field causes the liquid crystal molecules to rapidly incline with respect to the Z-direction. Therefore, regardless of the magnitude of the video signal to be written by the write operation subsequent to the pre-write operation, the change in configurational state can be completed just after starting the write operation. Accordingly, when the pre-write operation is executed, a high response speed can be achieved.

In the driving method, the pre-write operation and the write operation may be executed in this order in each selection period of the third and subsequent field periods. In this case, a short response time can be achieved also in the field period just after writing video signals that set the absolute value of the voltage applied to the liquid crystal layer 30 at the maximum value on the pixels PX.

Only two fields may constitute each frame. That is, the third field period may be omitted.

The field period in which the reset operation is executed may not be in the first field period of each frame. For example, it is possible that the write operation is executed in the first field period, the reset operation is executed in the second field period, and the pre-write operation and the write operation are executed in the third field period.

The reset operation may be executed only in one or some of the frame periods. Alternatively, the reset operation may be omitted. In any case, a short response time can be achieved, for example, in the field period just after writing video signals that set the absolute value of the voltage applied to the liquid crystal layer 30 at the maximum value on the pixels PX.

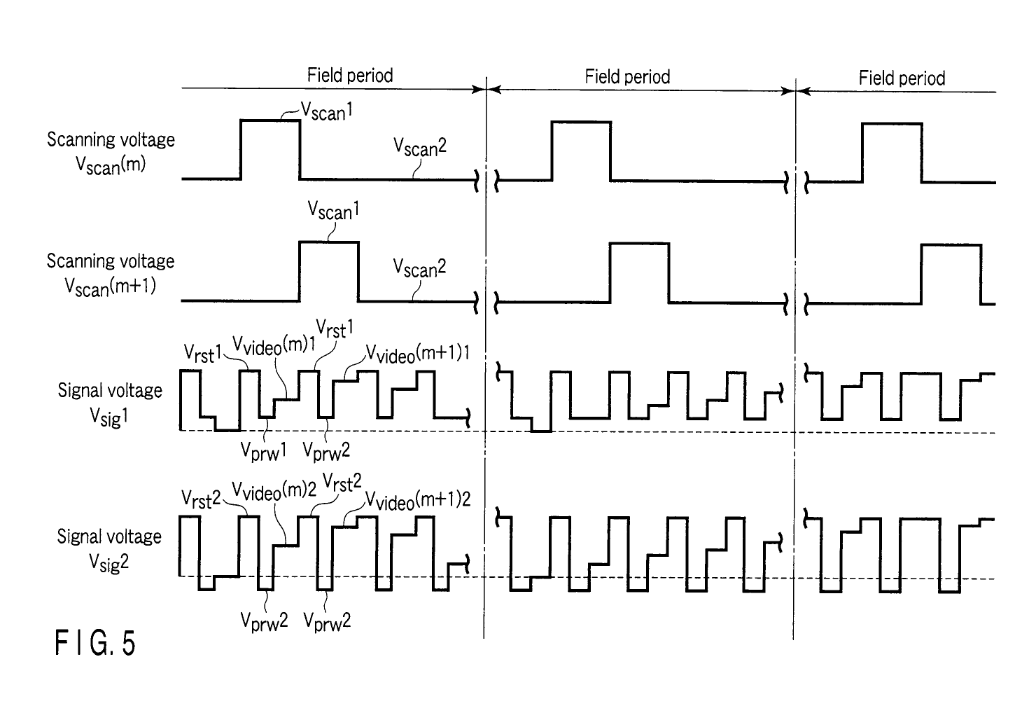

The controller 5 may control the operations of the driving circuits 2 to 4 according to the following method described with reference to FIG. 5.

In FIG. 5, the abscissa indicates time, and the ordinate indicates voltage. “V_{scan}1” and “V_{scan}2” represent the first and second scanning voltages, respectively. “Scanning voltage V_{scan}(m)” represents the waveform of the scanning voltage that the scanning line-driving circuit 2 outputs to the m-th scanning line 101a. “Signal voltage V_{sig}1” represents the waveform of the signal voltage that the signal line-driving circuit 3 outputs to the signal lines 105a connected to one of the pixels PX. “Signal voltage V_{sig}2” represents the waveform of the signal voltage that the signal line-driving circuit 3 outputs to the signal lines 105b connected to the particular pixel PX.

In the driving method shown in FIG. 5, one field constitutes each frame. In each field period, the reset operation, the pre-write operation and the write operation described above are executed in this order. Except for this regard, the driving method shown in FIG. 5 is the same as that described with reference to FIG. 4.

The driving method shown in FIG. 5 is greater in number of operations executed in one selection period than the driving method shown in FIG. 4. That is, in the case where the driving method shown in FIG. 5 is employed, the load on the signal line-driving circuit 3 is heavier as compared with the case where the driving method shown in FIG. 4 is employed.

However, according to the driving method shown in FIG. 5, since both the reset operation and the write operation are executed in one selection period, there is no period during which an image is not displayed. Thus, in the case where the driving method shown in FIG. 5 is employed, higher light utilization efficiency and a higher contrast ratio can be achieved as compared with the case where the driving method shown in FIG. 4 is employed.

In this driving method, one field constitutes each frame. Alternatively, two or more fields may constitute each frame. In this case, the reset operation and the pre-write operation may be executed in each field period, or the reset operation and the pre-write operation may be executed only in one or some of the field periods.

Further, in this driving method, the reset operation and the pre-write operation may be executed only in one or some of the frame periods.

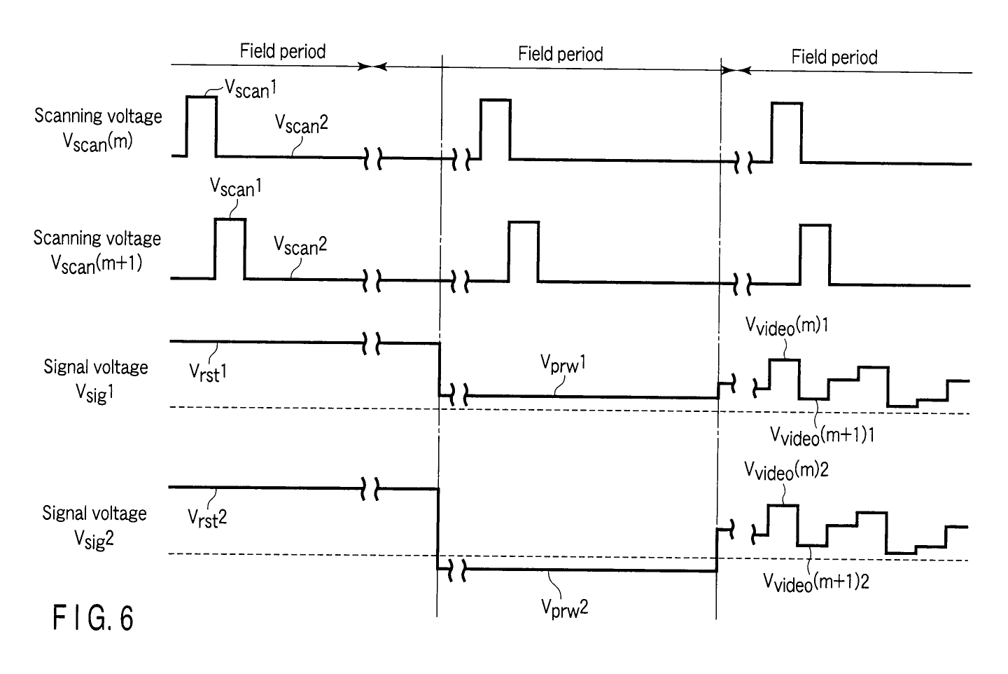

The controller 5 may control the operations of the driving circuits 2 to 4 according to the following method described with reference to FIG. 6.

In FIG. 6, the abscissa indicates time, and the ordinate indicates voltage. “V_{scan}1” and “V_{scan}2” represent the first and second scanning voltages, respectively. “Scanning voltage V_{scan}(m)” represents the waveform of the scanning voltage that the scanning line-driving circuit 2 outputs to the m-th scanning line 101a. “Signal voltage V_{sig}1” represents the waveform of the signal voltage that the signal line-driving circuit 3 outputs to the signal lines 105a connected to one of the pixels PX. “Signal voltage V_{sig}2” represents the waveform of the signal voltage that the signal line-driving circuit 3 outputs to the signal lines 105b connected to the particular pixel PX.

In the driving method shown in FIG. 6, three or more fields constitute each frame. In the first field period of each frame period, the reset operation described above is executed. In the second field period of each frame period, the pre-write operation described above is executed. In the third and subsequent field periods of each frame period, the write operation described above is executed. Except for this regard, the driving method shown in FIG. 6 is the same as that described with reference to FIG. 4.

According to the driving method shown in FIG. 6, the pre-write operation and the write operation are executed in different field periods. For this reason, in the driving method shown in FIG. 6, the proportion of the period during which no image is displayed in one frame period is higher than that in the driving method shown in FIG. 4.

However the driving method shown in FIG. 6 is smaller in number of operations executed in one selection period than the driving method shown in FIG. 4. That is, in the case where the driving method shown in FIG. 6 is employed, the load on the signal line-driving circuit 3 is lower as compared with the case where the driving method shown in FIG. 4 is employed.

In this driving method, the field period in which the reset operation is executed may be the field period other than the first period of each frame period. For example, it is possible that the write operation is executed in the first field period, the reset operation is executed in the second field period, the pre-write operation is executed in the third field period, and the write operation is executed in the fourth field period.

Further, in this driving method, the reset operation and the pre-write operation may be executed only in one or some of the frame periods.

In the driving methods described with reference to FIGS. 4 to 6, the signal line-driving circuit 3 simultaneously supplies the signal voltages to all the signal line groups. Alternatively, the signal line-driving circuit 3 may sequentially supply the signal voltages to the signal line groups.

In the case where each frame period includes two or more field periods in each of which the write operation is executed, the write operation executed in one field period and the write operation executed on another field period may be equal or different in the waveforms of the signal voltages that the signal line-driving circuit 3 outputs. In the latter case, a gray scale image can be displayed, for example, utilizing the time-ratio gray scale.

The potential V_{com} of the counter electrode 208 may be periodically changed between a first constant-potential and a second-constant potential. For example, the potential V_{com} of the counter electrode 208 may be periodically changed between the first constant-potential and the second-constant potential in synchronization with one or more frame periods.

Next, the second embodiment of the present invention will be described.

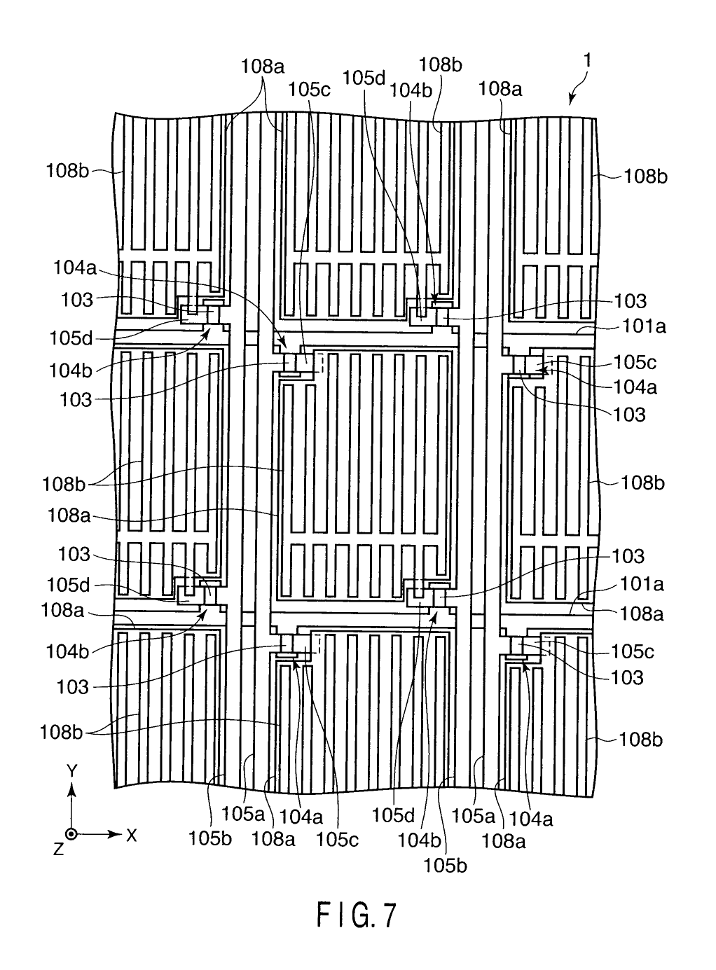

The liquid crystal display according the second embodiment is an OCB-mode active matrix liquid crystal display. The liquid crystal display is almost the same as the liquid crystal display described with reference to FIGS. 1 to 3 except that the gates of the switches 104a and 104b in each pixel are connected to different scanning lines 101a as shown in FIG. 7. Note that in FIG. 7, the color filter layer 220 and the reference lines 101b described above are omitted.

The liquid crystal display employing the structure shown in FIG. 7 can be driven, for example, by the method described with reference to FIG. 6. In this case, almost the same display performance can be achieved as in the case where the liquid crystal display described with reference to FIGS. 1 to 3 is driven by the driving method described with reference to FIG. 6.

In the display described above, the pixel electrodes 108b may be formed on the insulating film 102. That is, the pixel electrodes 108b may be adjacent to the pixel electrodes 108a on the insulating film 102. In this case, it is possible to use comb electrodes as the pixel electrodes 108a and 108b and place them such that the comb tooth portions of the pixel electrode 108a and the comb tooth portions of the pixel electrode 108b are arranged alternately. However, when such a structure is employed, leakage of light may occur between the pixel electrodes 108a and 108b.

The technique described above can be applied to various liquid crystal displays employ a display mode other than the OCB mode. For example, the technique described above can be applied to a π cell-mode liquid crystal display.

Examples of the present invention will be described below.

### EXAMPLE 1

In this example, the liquid crystal display described with reference to FIGS. 1 to 3 was manufactured by the following method.

In the manufacture of the array substrate 10, the scanning lines 101a and the reference lines 101b were first formed on a glass substrate 100. Chromium was used as the material of these lines.

Then, these lines were covered with the insulating film 102 made of silicon oxide. An amorphous silicon film was formed on the insulating film 102 and patterned into the semiconductor layers 103. After that, channel protection layers (not shown) made of silicon nitride were formed on the semiconductor layers 103, and ohmic layers (not shown) were formed on the semiconductor layers 103 and channel protection layers.

On the insulating film 102, the signal lines 105a and 105b and the source electrodes 105c and 105d were formed. In addition, the pixel electrodes 108a made of ITO were formed on the insulating film 102 to partially cover the source electrodes 105a, respectively. The pixel electrodes 108a were formed by depositing an ITO film and patterning it utilizing photolithography technique.

Thereafter, on the signal lines 105 and 105b, the source electrodes 105c and 105d and the pixel electrodes 108a, the insulating film 109 made of silicon nitride was deposited. In the insulating film 109, contact holes are formed at positions corresponding to the source electrodes 105d.

Then, on the insulating film 109, the pixel electrodes 108b made of ITO were formed to fill the contact holes, respectively. The pixel electrodes 108b were formed by depositing an ITO layer as a continuous film on the insulating film 109 and patterning the ITO layer utilizing photolithography technique.

In the manufacture of the counter substrate 20, a chromium film was first formed on the glass substrate 200 and patterned, thereby obtaining a black matrix. Subsequently, the striped color filter 220 was formed thereon using photosensitive acrylic resins in which red, green, and blue pigments were added.

Then, the color filter 207 was coated with a transparent acrylic resin to form a planarizing layer or overcoat (not shown). After that, ITO was sputtered on the planarizing layer to form the counter electrode 208. In addition, columnar spacers (not shown) having a height of 5 μm and bottom surface dimensions of 5 μm×10 μm were formed on the counter electrode 208 using photolithography. These columnar spacers were so formed as to be positioned above the signal lines 105a when the array substrate 10 and counter substrate 20 were adhered.

The pixel electrodes 108b and counter electrode 208 were cleaned, and coated with a polyimide solution (SE-5291 manufactured by Nissan Chemical Industries) by offset printing. A hotplate was used to heat these coating films at 90° C. for 1 minute, and then at 200° C. for 30 minutes. In this manner, the alignment layers 111 and 211 were formed.

The alignment layers 111 and 211 were then rubbed using cotton cloth. These rubbing processes were performed such that the rubbing directions of the alignment layers 111 and 211 were the same when the array substrate 10 and counter substrate 20 were adhered. To be more specific, the alignment layers 111 and 211 were rubbed such that the rubbing directions are parallel with the X-direction when the array substrate 10 and counter substrate 20 were adhered. Also, each rubbing was done by using cotton rubbing cloth whose fibers have a diameter of 0.1 to 10 μm at their tips, under the conditions that the rotational speed of the rubbing roller was 500 rpm, the substrate moving velocity was 20 mm/s, the pushing depth was 0.7 mm, and the number of times of rubbing was 1. After the rubbing, the alignment layers 111 and 211 were cleaned with an aqueous solution containing a neutral surfactant as its main component.

After that, the major surface of the counter substrate 20 was coated with an epoxy adhesive as the material of a sealing layer by using a dispenser so as to surround the alignment layer 211. Note that the frame formed by the adhesive layer was provided with an opening to be used as an injection port later. Subsequently, the array substrate 10 and the counter substrate 20 were aligned such that the alignment layers 111 and 211 faced each other and their rubbing directions were equal to each other. After this alignment, the array substrate 10 and the counter substrate 20 were adhered and heated to 160° C. under pressure, thereby curing the adhesive.

Subsequently, the empty cell thus obtained was loaded into a vacuum chamber, and evacuated. After that, a liquid crystal material was injected into the cell from the injection port. As the liquid crystal material, E7 (manufactured by Merck, Japan) as a nematic liquid crystal composition was used.

Then, the injection port was sealed with an epoxy adhesive. Thus, a liquid crystal cell was obtained. Note that the cell gap of the liquid crystal cell was about 5 μm.

Then, the optical compensation film 40 and the polarizer 50 were adhered to one of the main surfaces of the liquid crystal cell. To another main surface of the liquid crystal cell, the optical compensation film 40 and the polarizer 50 were adhered, too. Here, this display was so designed that when a voltage of 5V was applied between the pixel electrodes 108b and the counter electrode 208, the sum of the retardation of the liquid crystal layer 30 at positions corresponding to the pixel electrodes 108b and the retardations of the optical compensation films 40 was substantially zero. Also, the polarizers 50 were so arranged that their transmission axes were substantially perpendicular to each other, and each transmission axis is almost parallel with the X-direction or Y-direction.

In addition, the driving circuits 2 to 4, etc. were connected to the array substrate 10, and the driving circuits 2 to 4 were connected to the controller 5. Further, the display panel 1 thus obtained and a backlight were assembled. In this way, a QVGA-type liquid crystal display was completed.

The liquid crystal display was driven by the method described with reference to FIG. 4.

To be more specific, two fields constituted each frame. That is, the third and subsequent field periods described with reference to FIG. 4 were omitted. The duration of the first field period for applying the reset voltage was set at 3.2 milliseconds, and the duration of the second field period was set at 13.5 milliseconds. In the second field period of each frame period, the pre-write signals V_{prw}1 and V_{prw}2 were supplied to the signal lines 105a and 105b, respectively, for 56 microseconds in each selection period.

The reset voltage Vᵣₛₜ1−V_{com} was set at 6V, and the reset voltage Vᵣₛₜ2−V_{com} was set at 5V. The difference between the pre-write signal V_{prw}1 and the potential V_{com} of the counter electrode 208 was set at 2.5V, and the difference between the pre-write signal V_{prw}2 and the potential V_{com} of the counter electrode 208 was set at −2V. Further, the video signal voltages V_{video}1−V_{com} and V_{video}2−V_{com} were set at 0V.

When the liquid crystal display was driven under these conditions, a response time of 3.5 milliseconds was achieved. In addition, when a white image and a black image were displayed on the liquid crystal display under these conditions, a contrast ratio of 1000:1 was achieved.

### EXAMPLE 2

In this example, the liquid crystal display manufactured in Example 1 was driven by the method described with reference to FIG. 5. To be more specific, one field constitutes each frame, and the duration of each field period was set at 16.7 milliseconds. In each selection period, the signal lines 105a and 105b were supplied with the pre-write signals V_{prw}1 and V_{prw}2, respectively, for 23 microseconds. The other conditions were the same as those in Example 1.

When the liquid crystal display was driven under these conditions, a response time of 4 milliseconds was achieved. In addition, when a white image and a black image were displayed on the liquid crystal display under these conditions, a contrast ratio of 1200:1 was achieved.

### EXAMPLE 3

In this example, the liquid crystal display manufactured in Example 1 was driven by the method described with reference to FIG. 6. To be more specific, three fields constitute each frame, the duration of the first field period was set at 1.5 milliseconds, the duration of the second field period was set at 1.5 milliseconds, and the duration of the third field period was set at 13.7 milliseconds. In the second field period of each frame period, the signal lines 105a and 105b were supplied with the pre-write signals V_{prw}1 and V_{prw}2, respectively, for 1.5 milliseconds in each selection period. The other conditions were the same as those in Example 1.

When the liquid crystal display was driven under these conditions, a response time of 3 milliseconds was achieved. In addition, when a white image and a black image were displayed on the liquid crystal display under these conditions, a contrast ratio of 1000:1 was achieved.

### COMPARATIVE EXAMPLE

Manufactured was a liquid crystal display having the same structure as that of the liquid crystal display manufactured in Example 1 except that the pixel electrodes 108b were omitted and the pixel electrodes 108a were placed between the insulating film 109 and the alignment layer 111. The liquid crystal display was driven by the same method as that described in Example 3 except that the field period for the pre-write operation was omitted. Note that the driving conditions were the same as those in Example 3 except that the reset voltage Vᵣₛₜ1−V_{com} was set at 5V and the reset voltage Vᵣₛₜ2−V_{com} was set at 0V.

When the liquid crystal display was driven under these conditions, a response time of 5.5 milliseconds was achieved. In addition, when a white image and a black image were displayed on the liquid crystal display under these conditions, a contrast ratio of 800:1 was achieved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display comprising:
an array substrate comprising a first insulating substrate, signal line groups supported by the first insulating substrate and each including first and second signal lines, and pixel circuits arranged along the signal line groups and each including first and second pixel electrodes, a first switch connected between the first pixel electrode and the first signal line included in one of the signal line groups, and a second switch connected between the second pixel electrode and the second signal line included in said one of the signal line groups;
a counter substrate comprising a second insulating substrate facing the first insulating substrate with the pixel circuits interposed therebetween, and a counter electrode supported by the second insulating substrate and facing the pixel circuits; and
a liquid crystal layer interposed between the array substrate and the counter substrate.

2. The display according to claim 1, wherein liquid crystal molecules included in the liquid crystal layer form a bend configuration when an image is displayed.

3. The display according to claim 1, wherein the second pixel electrode faces the first insulating substrate with a part of the first pixel electrode interposed therebetween.

4. The display according to claim 3, wherein the second pixel electrode is provided with slits.

5. The display according to claim 4, wherein the array substrate further comprises a first alignment layer covering the first and second pixel electrodes, and the counter substrate further comprises a second alignment layer covering the counter electrode, a longitudinal direction of the slits being perpendicular to or oblique to an orthogonal projection onto the first insulating substrate of a direction in which the first and second alignment layers make liquid crystal molecules tilt.

6. The display according to claim 1, wherein the array substrate further comprises scanning lines supported by the first insulating substrate, in each of the pixel circuits, the first switch being a first thin-film transistor with a gate connected to one of the scanning lines, and the second switch being a second thin-film transistor with a gate connected to said one of the scanning lines.

7. The display according to claim 1, wherein the array substrate further comprises scanning lines supported by the first insulating substrate, in each of the pixel circuits, the first switch being a first thin-film transistor with a gate connected to one of the scanning lines, and the second switch being a second thin-film transistor with a gate connected to another of the scanning lines.

8. The display according to claim 1, wherein the array substrate further includes scanning lines supported by the first insulating substrate, and the display further comprises:
a scanning line-driving circuit sequentially supplying scanning voltages for closing the first and second switches to the scanning lines;
a signal line-driving circuit supplying first and second signal voltages to the first and second signal lines included in each of the signal line groups, respectively; and
a controller connected to the scanning line-driving circuit and the signal line-driving circuit and controlling operations of the scanning line-driving circuit and the signal line-driving circuit.

9. The display according to claim 8, wherein the controller controls the operations of the scanning line-driving circuit and the signal line-driving circuit such that a pre-write operation and a write operation are executed in this order,
the pre-write operation including supplying first and second pre-write signals to the first and second signal lines included in each of the signal line groups, respectively, in a selection period during which the scanning line-driving circuit supplies the scanning voltage to one of the scanning lines, to apply a pre-write voltage between the first and second pixel electrodes, and
the write operation including supplying first and second video signals to the first and second signal lines included in each of the signal line groups, respectively, in the selection period, an absolute value of a difference between the first and second video signals being smaller than an absolute value of the pre-write voltage.

10. The display according to claim 9, wherein the controller controls the operations of the scanning line-driving circuit and the signal line-driving circuit such that the pre-write operation and the write operation are executed in this order in each field period.

11. The display according to claim 9, the controller controls the operations of the scanning line-driving circuit and the signal line-driving circuit such that a reset operation is executed before the pre-write operation,
the reset operation including supplying first and second reset signals to the first and second signal lines included in each of the signal line groups, respectively, in a period during which the scan signal line-driving circuit supply the scanning voltage to one of the scanning lines, to apply first and second reset voltages between the first pixel electrode and the counter electrode and between the second pixel electrode and the counter electrode, respectively, an absolute value of the first reset voltage being equal to or greater than an absolute value of a voltage between the first pixel electrode and the counter electrode just after the pre-write operation and an absolute voltage of a voltage between the first pixel electrode and the counter electrode just after the write operation, and an absolute value of the second reset voltage being equal to or greater than an absolute value of a voltage between the second pixel electrode and the counter electrode just after the pre-write operation and an absolute voltage of a voltage between the second pixel electrode and the counter electrode just after the write operation.

12. The display according to claim 11, wherein the controller controls the operations of the scanning line-driving circuit and the signal line-driving circuit such that the reset operation is executed in a first field period, and the pre-write operation and the write operation are executed in this order in a second field period subsequent to the first field period.

13. The display according to claim 11, wherein the controller controls the operations of the scanning line-driving circuit and the signal line-driving circuit such that the reset operation, the pre-write operation and the write operation are executed in this order in each field period.

14. A method of driving a liquid crystal display comprising an array substrate comprising a first insulating substrate and pixel circuits each including first and second pixel electrodes facing the first insulating substrate, a counter substrate comprising a second insulating substrate facing the first insulating substrate with the pixel circuits interposed therebetween and a counter electrode supported by the second insulating substrate and facing the pixel circuits, and a liquid crystal layer interposed between the array substrate and the counter substrate, comprising:
selecting the pixel circuits one-by-one or line-by-line;
executing a pre-write operation including supplying first and second pre-write signals to the first and second pixel electrodes included in the selected pixel circuit, respectively, to apply a pre-write voltage between the first and second pixel electrodes; and
after the pre-write operation, executing a write operation including supplying first and second video signals to the first and second pixel electrodes included in the selected pixel circuit, respectively, an absolute value of a difference between the first and second video signals being smaller than an absolute value of the pre-write voltage.

15. The method according to claim 14, wherein liquid crystal molecules included in the liquid crystal layer form a bend configuration when an image is displayed.

16. The method according to claim 14, wherein the pre-write operation and the write operation are executed in this order in each field period.

17. The method according to claim 14, wherein a reset operation is executed before the pre-write operation,
the reset operation including supplying first and second reset signals to the first and second pixel electrodes included in the selected pixel circuit, respectively, to apply first and second reset voltages between the first pixel electrode and the counter electrode and between the second pixel electrode and the counter electrode, respectively, an absolute value of the first reset voltage being equal to or greater than an absolute value of a voltage between the first pixel electrode and the counter electrode just after the pre-write operation and an absolute voltage of a voltage between the first pixel electrode and the counter electrode just after the write operation, and an absolute value of the second reset voltage being equal to or greater than an absolute value of a voltage between the second pixel electrode and the counter electrode just after the pre-write operation and an absolute voltage of a voltage between the second pixel electrode and the counter electrode just after the write operation.

18. The method according to claim 17, wherein the reset operation is executed in a first field period, and the pre-write operation and the write operation are executed in this order in a second field period subsequent to the first field period.

19. The method according to claim 17, wherein the reset operation, the pre-write operation and the write operation are executed in this order in each field period.
